(19) United States
(12) Patent Application Publication
(10) Pub. No.: US 2009/0080011 A1
(43) Pub. Date: Mar. 26, 2009

(54) NETWORK PORT SETUP FOR PRINTER DRIVER FOR A NETWORKED PRINTER

(75) Inventor: Zhongming Shen, SUNNYVALE, CA (US)

Correspondence Address: YING CHEN;Chen Yoshimura LLP, 255 S. GRAND AVE., # 215, LOS ANGELES, CA, 90012, US

(73) Assignee: KONICA MINOLTA SYSTEMS LABORATORY, INC., Huntington Beach, CA (US)

(21) Appl. No.: 11/862,041

(22) Filed: Sep. 26, 2007

(51) Int. Cl. G06F 15/00

(52) U.S. Cl. 358/1.15

(57) ABSTRACT

A method and apparatus for setting up a printer driver for a networked printer by providing a dedicated configuration button on the printer. During printer driver setup, the user pushes the configuration button on the printer to cause the printer to broadcast a configuration event over the network the printer is connected to. The configuration event contains information regarding the printer's network address. The host computer that is performing a printer driver setup process will receive the event, which allows the host computer to automatically perform printer driver installation. This process eliminates the need to manually find out the printer's network address or type the network address on the host during printer driver setup.

This application is related to commonly owned patent application entitled “Reconnecting a Host Computer with a Networked Printer Having a Dynamic Network Address,” Attorney Docked No. 75675.B157, filing date to be determined.

### BACKGROUND OF THE INVENTION

1. Field of the Invention

This invention relates to a networked printer system, and in particular, it relates to a method for easy network port setup for printer driver on a host computer for a networked printer.

2. Description of Related Art

For a typical network capable printer, before a user sets up the printer on the host computer, the user needs to find out the printer's network address (e.g. IP address) by either checking the printer's control panel by going through a series of menu buttons, or printing out a printer configuration page. After the user obtains the printer's network address, the user needs to type it in the host computer's printer setup program. This process tends to be cumbersome, confusing and error prone.

### SUMMARY

Accordingly, the present invention is directed to a method and apparatus of facilitate easy printer driver setup that substantially obviates one or more of the problems due to limitations and disadvantages of the related art.

An object of the present invention is to provide an easy way to set up a printer driver on a host computer for a networked printer.

Additional features and advantages of the invention will be set forth in the descriptions that follow and in part will be apparent from the description, or may be learned by practice of the invention. The objectives and other advantages of the invention will be realized and attained by the structure particularly pointed out in the written description and claims thereof as well as the appended drawings.

To achieve these and/or other objects, as embodied and broadly described, the present invention provides a method implemented in a system including one or more host computers and one or more printers connected to a network, the one or more host computers for setting up a printer driver on a first one of the host computers for a first one of the printers, the method including: (a) manually causing the first printer to generate a configuration event containing a network address of the first printer, the network address being previously stored in a memory of the first printer; (b) the first printer sending the configuration event over the network to be transmitted to the one or more host computers; (c) the first host computer receiving the configuration event and extracting the network address of the first printer; and (d) the first host computer automatically setting up the printer driver using the extracted network address of the first printer.

In another aspect, the present invention provides a printer, which includes: a processor; a memory for storing an IP address of the printer; a manual input device connected to the processor; and a network interface for connecting the printer to a network; wherein the processor is programmed to generate a configuration event in response to an input from the manual input device and transmitting the configuration event to a network via the network interface, the configuration event containing a network address of the printer previously stored in the memory.

In another aspect, the present invention provides a computer program product including a computer usable medium having a computer readable program code embedded therein for controlling a host computer, the computer readable program code configured to cause the host computer to execute a process for setting up a printer driver for a printer, the host computer and the printer being connected to a network, the printer capable of transmitting a configuration event over the network, the configuration event containing a network address of the printer, the process including: receiving the configuration event from the printer via the network; extracting the network address of the printer from the configuration event; and setting up the printer driver using the extracted network address of the printer.

It is to be understood that both the foregoing general description and the following detailed description are exemplary and explanatory and are intended to provide further explanation of the invention as claimed.

### BRIEF DESCRIPTION OF THE DRAWINGS

FIG. 1 is a block diagram of a host computer in which embodiments of the present invention may be implemented.

FIG. 2 is a block diagram of a printer according to an embodiment of the present invention.

FIG. 3 illustrates a process carried out by the printer installer application of the host computer according to an embodiment of the present invention.

FIG. 4 illustrates a process carried out on a networked printer being set up according to embodiments of the present invention.

FIG. 5 illustrates a method of setting up a printer driver on a host computer for a networked printer according to embodiments of the present invention.

FIG. 6 illustrates a networked computer and printer system in which embodiments of the present invention may be implemented.

### DETAILED DESCRIPTION OF PREFERRED EMBODIMENTS

Embodiments of the present invention introduce an easier and simpler mechanism that improves the user experience for printer and printer driver setup by providing a dedicated configuration button on the printer. During printer driver setup, the user can simply push the configuration button to cause the printer to broadcast a configuration event over the network the printer is connected to. The configuration event contains information regarding the printer's network address. The host computer that is performing a printer driver setup process will receive the event, which allows the host computer to automatically perform printer driver installation. This process eliminates the need to manually find out the printer's network address or type the network address on the host.

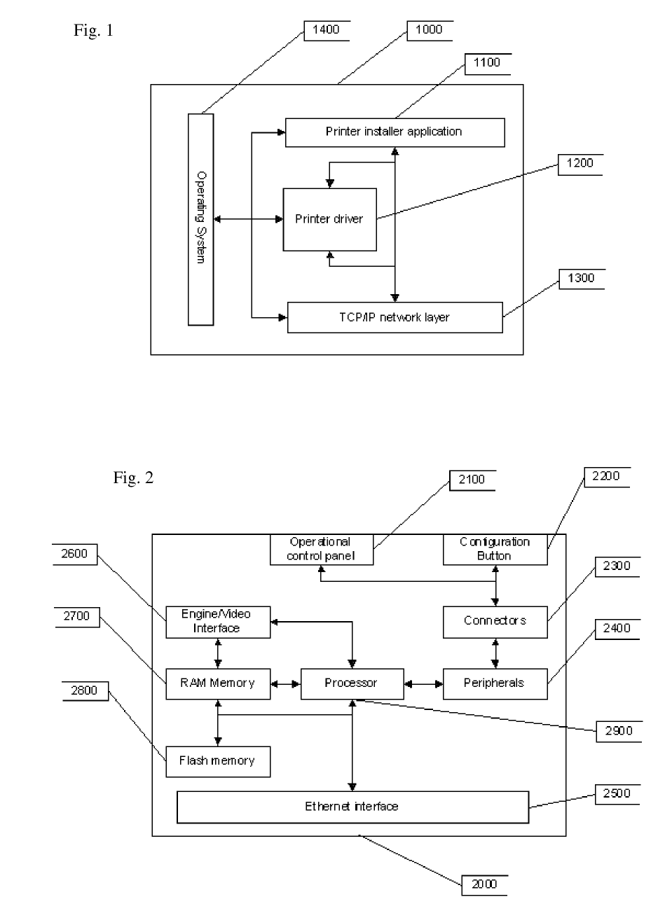

FIG. 1 illustrates a host computer in which embodiments of the present invention may be implemented. In relevant part, the host computer 1000 includes an operating system 1400, a TCP/IP layer 1300 for carrying out communication over a network, a printer driver module 1200, and a printer installer application 1100. As apparent for an artisan, the printer driver module 1200 will reside in the host computer 1000 after being installed by the printer installer application 1100. These various components communicate with each other via internal structures of the computer well know to those skilled in the art. FIG. 2 illustrates a printer in which embodiments of the invention may be implemented. In relevant part, the printer 2000 includes an operation control panel 2100, a configuration button 2200, connectors 2300, peripheral chips 2400, a network interface (such as an Ethernet interface) 2500, an engine/video interface 2600, a RAM memory 2700, a flash memory 2800 and a processor 2900. These various components communicate with each other via internal structures of the printer well know to those skilled in the art. While a dedicated configuration button is an example of a convenient manual input device for causing the printer to generate a configuration event, other manual input devices may be used, such as a touch screen implementing a menu tree structure, a certain combination of a plurality of buttons, etc.

FIG. 6 illustrates a networked computer and printer system 10 which includes a plurality of printers 11 and a plurality of host computers 12 connected via a network 13. The network 13 may be any suitable network, including but not limited to a LAN, WAN, Ethernet, the Internet, etc. The printers 11 and the host computers 12 may be connected to the network via wired or wireless connections.

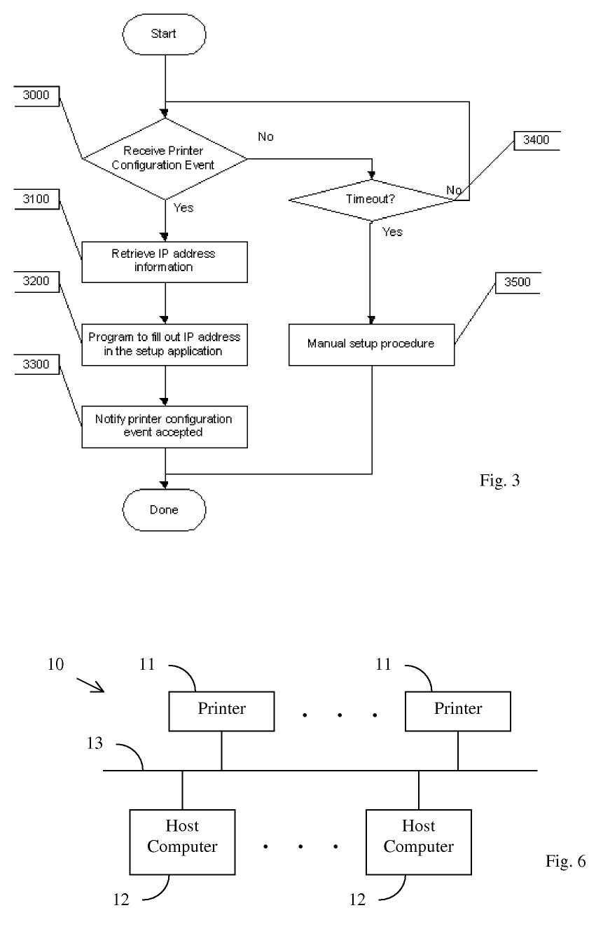

A process carried out by the printer installer application 1100 of the computer 1000 is shown in FIG. 3. After the printer installer application 1100 starts, it waits to receive a printer configuration event from the network (step 3000). If the printer installer application receives a configuration event from the network, it retrieves the network address information contained therein (step 3100). In the next step, the printer installer application uses the network address to fill out the network address field in the installer application to set up the network port for the printer (step 3200). In step 3300, the computer sends a configuration acknowledgement message to the printer to notify it that the configuration event and the network address information have been accepted by this host for printer setup. The printer installer application also completes the other steps of printer driver installation (not shown) in a way similar to the conventional method. If, after the printer installer application 1100 starts, it does not receive any configuration event from the network with a predetermined time period (“yes” in step 3400), the automatic setup process times out, and a manual setup procedure is started (step 3500). The manual setup procedure is similar to that in the conventional art.

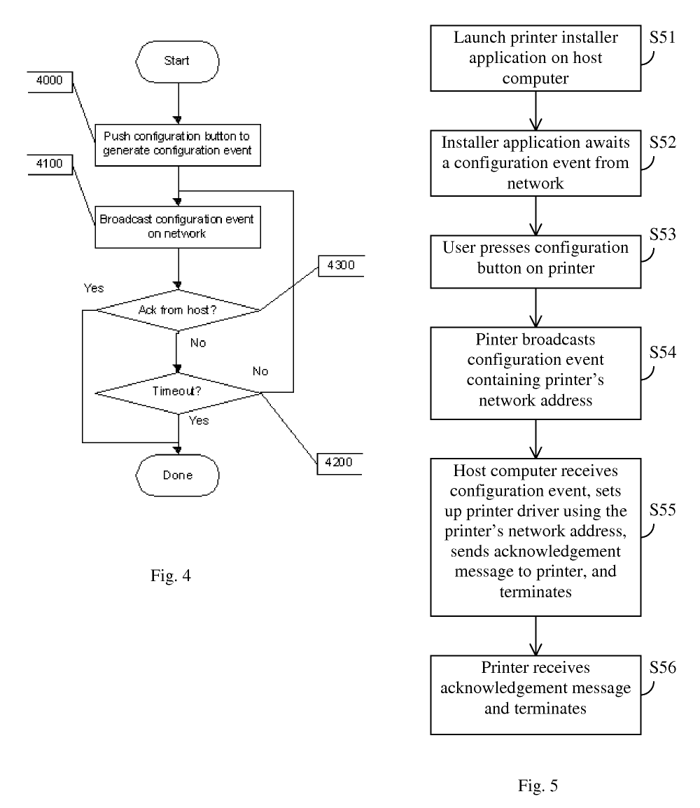

A process carried out by the printer controller of a networked printer being set up is illustrated in FIG. 4. This process is implemented in firmware or software on the printer controller. As described earlier, during the printer driver setup process, the user presses the configuration button on the printer. In response to the configuration button being pressed, the printer controller generates a configuration event (step 4000) and broadcasts the event on the network (step 4100). This broadcast event contains the printer's network address such as its IP address, which has already been temporally or permanently stored in either of the RAM 2700 or the flash memory 2800 depending on the type of network configuration the network employs (dynamic or static network configuration). This broadcast procedure is repeated until a configuration acknowledgement message from a host computer is received from the network (“Yes” in step 4300), or until timeout (“Yes” in step 4200).

The setup process is summarized in FIG. 5. First, the printer installer application is launched on the host computer (step S51). The installer program may be launched by the user manually, or automatically launched, for example, when the user inserts a setup disc into the host computer. The installer application awaits a configuration event from the network (step S52). When the user presses the configuration button on the printer that the user wishes to setup (step S53), the printer broadcasts a configuration event containing the printer's network address (step S54). Alternatively, instead of a broadcast event, the printer may scan possible network addresses (e.g. IP addresses) within a certain range (e.g. one subnet where all IP addresses have the same number except for the last three digits) by sending the configuration event to all such network addresses sequentially. The printer may also send the configuration event to specific IP addresses in a point-to-point communication. While many host computers may be connected to the same network, those host computers that are not running a printer installer application will ignore the configuration event. The host computer that has the printer installer application running on it receives the configuration event and sets up the printer driver using the printer's network address contained in the configuration event (step S55). In this step, the host computer also sends a configuration acknowledgement message to the printer. The printer receives the acknowledgement message and terminates the broadcast (step S56).

It will be apparent to those skilled in the art that various modification and variations can be made in the network port setup method of the present invention without departing from the spirit or scope of the invention. Thus, it is intended that the present invention cover modifications and variations that come within the scope of the appended claims and their equivalents.

What is claimed is:

1. In a system including one or more host computers and one or more printers connected to a network, a method for setting up a printer driver on a first one of the host computers for a first one of the printers, comprising:
(a) manually causing the first printer to generate a configuration event containing a network address of the first printer, the network address being previously stored in a memory of the first printer;
(b) the first printer sending the configuration event over the network to be transmitted to the one or more host computers;
(c) the first host computer receiving the configuration event and extracting the network address of the first printer; and
(d) the first host computer setting up the printer driver using the extracted network address of the first printer.

2. The method of claim 1, further comprising:
the first host computer sending a configuration acknowledgement message to the first printer; and
the first printer receiving the configuration acknowledgement message.

3. The method of claim 1, wherein step (b) includes broadcasting the configuration event over the network to all host computers.

4. A printer, comprising:
a processor;
a memory for storing a network address of the printer;
a manual input device connected to the processor; and
a network interface for connecting the printer to a network;
wherein the processor is programmed to generate a configuration event in response to an input from the manual input device and transmitting the configuration event to a network via the network interface, the configuration event containing a network address of the printer previously stored in the memory.

5. The printer of claim 4, wherein the processor is programmed to repeatedly transmit the configuration event to the network for a predetermined period of time or until a configuration acknowledgement message is received from the network.

6. A computer program product comprising a computer usable medium having a computer readable program code embedded therein for controlling a host computer, the computer readable program code configured to cause the host computer to execute a process for setting up a printer driver for a printer, the host computer and the printer being connected to a network, the printer capable of transmitting a configuration event over the network, the configuration event containing a network address of the printer, the process comprising:
receiving the configuration event from the printer via the network;
extracting the network address of the printer from the configuration event; and
setting up the printer driver using the extracted network address of the printer.

7. The computer program product of claim 6, wherein the process further comprises:
transmitting a configuration acknowledgement message over the network.
